(19) United States
(12) Patent Application Publication
(10) Pub. No.: US 2026/0281727 A1
(43) Pub. Date: Sep. 17, 2026

(54) LINKING OF COMMUNICATIONS DEVICE SUBSCRIBER IDENTIFIERS FOR FRAUD DETECTION

(71) Applicant: Prove Identity, Inc., New York, NY (US)

(72) Inventor: Ryan Alexander, Snohomish, WA (US)

(21) Appl. No.: 19/669,557

(22) Filed: May 6, 2026

Related U.S. Application Data
(63) Continuation of application No. 17/591,444, filed on Feb. 2, 2022.

(51) Int. Cl. H04W 12/122; H04W 12/06; H04W 12/72; H04W 24/10

(52) U.S. Cl. CPC H04W 12/122; H04W 12/068; H04W 12/72; H04W 24/10

(57) ABSTRACT

Briefly, example methods, apparatuses, and/or articles of manufacture may be implemented to detect and/or prevent fraud that involves a communications device. The method may include transmitting, from a client computing resource to an authenticator, a subscriber identifier suspected of participating in a first fraudulent transaction. The method may further include obtaining, from the authenticator, one or more subscriber identifiers previously or subsequently assigned to the communications device by a communication services carrier.

### CROSS-REFERENCE TO RELATED APPLICATION

This application is a continuation of co-pending U.S. Patent Application No. 17/591,444, filed on Feb. 2, 2022, the entire contents of which are incorporated herein by reference.

### BACKGROUND

### 1. Field

The present disclosure relates generally to detection and/or prevention of fraud in electronic transactions, such as may occur utilizing a communications device within a communications infrastructure.

### 2. Information

The World Wide Web or simply the Web, as enabled by Internet computing, routing, and/or wireless transmission resources, has grown rapidly in recent years at least partially in response to the relative ease with which a wide variety of electronic transactions can be performed or enabled via the Internet. As a consequence of widely available Internet connections, including connections to the Internet facilitated by wireless mobile communication services, for example, a mobile subscriber may shop and/or purchase virtually any product or service utilizing a handheld communications device. However, in such an environment, in which electronic, Internet-based commerce has become increasingly common, occurrences of fraud and deception, unfortunately, can also occur.

In addition to facilitating communications among devices having a primary purpose that relates to providing communication services, such as mobile cellular communications devices, the Web also facilitates communication among devices providing other functionalities, such as appliances, industrial, commercial, and household machines, control devices, sensors, etc. In such an environment, which may be referred to as an “Internet of things” (IOT) environment, as well as situations involving devices designed primarily for communications, instances of fraud and deception may bring about unreliable operation, intrusion by unauthorized parties into a user's home network, theft of privileged content, financial and/or credit card fraud, and so forth. To reduce a likelihood of fraud, theft, or intrusion by unauthorized parties, fraud-detection and/or user authentication processes may be implemented. Such implementations may be utilized, for example, in connection with numerous types of web-based or electronic transactions or operations. Thus, it may be appreciated that reduction in the instances of fraud and deception, which may involve, for example, use of various types of communications devices, continues to be an active area of investigation.

### SUMMARY

One general aspect includes a method to detect and/or prevent fraud that involves a communications device, including transmitting, from a client computing resource to an authenticator, a subscriber identifier suspected of participating in a first fraudulent transaction. The method also includes obtaining, from the authenticator, one or more subscriber identifiers previously or subsequently assigned to the communications device by a communication services carrier. Other embodiments of this aspect include corresponding computer systems, apparatuses, and computer programs recorded on one or more computer storage devices, each configured to perform the actions of the methods.

In particular embodiments, the method may further include determining whether at least one of the one or more subscriber identifiers previously or subsequently assigned to the communications device is suspected of participating in a second fraudulent transaction. In particular embodiments, the previously or subsequently assigned subscriber identifiers include at least one telephone number of a chain of telephone numbers that has been modified via a change to a mobile station international subscriber directory number of the communications device. In particular embodiments, the method may further include obtaining from the authenticator a measure of velocity or a measure of frequency of the one or more subscriber identifiers being previously or subsequently assigned to the communications device by the communication services carrier. In particular embodiments, the method may further include obtaining a trust score and a reliability metric that qualifies the trust score from the authenticator based, at least in part, on the authenticator and either the measure of velocity or the measure of frequency of changes to the mobile station international subscriber directory number of the communications device. In particular embodiments, the obtained trust score corresponds to a quantity computed utilizing deterministic behaviors with respect to the communications device. In particular embodiments, the deterministic behaviors with respect to the communications device include one or more of communications device tenure, removal and/or replacement of a subscriber identity module (SIM) of the communications device, use of a one-time code to reset an account password of the communications device, and/or recent porting of a telephone number corresponding to the communications device. In particular embodiments, the obtained reliability metric corresponds to the measure of velocity or the measure of frequency with which the one or more subscriber identifiers were previously or subsequently assigned to the communications device by the communication services carrier. In particular embodiments, the method may further include designating for monitoring one or more of a currently-assigned subscriber identifier and the one or more subscriber identifiers previously-assigned to the communications device, based at least in part on the obtained reliability metric being less than a threshold. In particular embodiments, the method may further include receiving, via a user interface to a web browser, the subscriber identifier suspected of participating in the first fraudulent transaction.

In one general aspect, a method of responding to an indication of suspected fraud involving a communications device may include obtaining, from a client computing resource, a subscriber identifier. The method of responding may also include determining whether a link exists between the obtained subscriber identifier and one or more subscriber identifiers previously or subsequently assigned to the communications device. The method may also include transmitting, to the client computing resource, the one or more subscriber identifiers previously or subsequently assigned to the communications device.

In particular embodiments, the method may further include transmitting a trust score to the client computing resource. In particular embodiments, the method may further include computing the trust score based, at least in part, on deterministic behaviors with respect to the communications device. In particular embodiments, the deterministic behaviors with respect to the communications device include communications device tenure, removal and/or replacement of a subscriber identity module (SIM) of the communications device, use of a one-time code to reset an account password of the communications device, or recent porting of a telephone number corresponding to the communications device. In particular embodiments the method may further include transmitting a reliability metric to the client computing resource. In particular embodiments, the method may further include computing the reliability metric based, at least in part, on a measure of velocity or a measure of frequency with which the one or more subscriber identifiers were previously or subsequently assigned to the communications device by the communication services carrier. The method may further include designating for monitoring one or more of the currently-assigned subscriber identifier and the one or more subscriber identifiers previously or subsequently assigned to the communications device, based, at least in part on, the obtained reliability metric being less than a threshold. In particular embodiments, the method may further include obtaining the subscriber identifier from the client computing resource occurs responsive to establishing a web browser-based session having an interface to accept input signals from a user.

In another general aspect, a non-transitory computer-readable media having instructions encoded thereon which, responsive to execution of the encoded instructions by a computer processor coupled to at least one memory device, may direct the computer processor to transmit, from a client computing resource to an authenticator, a subscriber identifier suspected of participating in a first fraudulent transaction. In particular embodiments, the computer processor coupled to the at least one memory may also be to obtain, from the authenticator, one or more subscriber identifiers previously or subsequently assigned to the communications device by a communication services carrier. In particular embodiments, the encoded instructions may additionally be to initiate a web browser-based session with the client computing resource prior to directing the computer processor to transmit the subscriber identifier to the authenticator.

Another general aspect relates to an apparatus to detect fraud that involves a communications device, including a processor coupled to at least one memory device to transmit, from a client computing resource to an authenticator, a subscriber identifier suspected of participating in a first fraudulent transaction. The apparatus may additionally be to obtain, from the authenticator, one or more subscriber identifiers previously or subsequently assigned to the communications device by a communication services carrier.

In particular embodiments, the processor coupled to the at least one memory is additionally to determine whether at least one of the one or more subscriber identifiers previously or subsequently assigned to the communications device is suspected of participating in a second fraudulent transaction. In particular embodiments, the processor coupled to the at least one memory is additionally to obtain from the authenticator a measure of velocity or a measure of frequency with which the one or more subscriber identifiers were previously or subsequently assigned to the communications device by the communication services carrier. In particular embodiments, the processor coupled to the at least one memory is additionally to obtain a trust score and a reliability metric that qualifies to the trust score from the authenticator. In particular embodiments, the obtained trust score is to correspond to a quantity computed utilizing deterministic behaviors with respect to the communications device. In particular embodiments, the deterministic behaviors with respect to the communications device are to correspond to communications device tenure, removal and/or replacement of a subscriber identity module (SIM) of the communications device, use of a one-time code to reset an account password of the communications device, recent porting of a telephone number corresponding to the communications device, or any combination thereof. In particular embodiments, the processor coupled to the at least one memory is additionally to designate for monitoring one or more of the subscriber identifiers previously or subsequently assigned to the communications device, based at least in part on the obtained reliability metric being less than a threshold. In particular embodiments, the processor coupled to the at least one memory is additionally to receive, via a user interface to a web browser that communicates with the client computing resource via a network, the subscriber identifier suspected of participating in the first fraudulent transaction. Implementations of the described techniques may include hardware, a method or process, or computer software on a computer-accessible medium.

Another general aspect relates to an apparatus to respond to an indication of suspected fraud involving a communications device, including a processor coupled to at least one memory device to obtain, from a client computing resource, a subscriber identifier. The apparatus may also detect a link between the obtained subscriber identifier and one or more subscriber identifiers previously or subsequently assigned to the communications device. The apparatus may also transmit, to the client computing resource, the one or more subscriber identifiers previously or subsequently assigned to the communications device.

In particular embodiments, the processor coupled to the at least one memory is additionally to transmit a trust score to the client computing resource. In particular embodiments, the processor coupled to the at least one memory is additionally to compute the trust score based, at least in part, on deterministic behaviors with respect to the communications device, in which the deterministic behaviors correspond to communications device tenure, removal and/or replacement of a subscriber identity module (SIM) of the communications device, use of a one-time code to reset an account password of the communications device, recent porting of a telephone number corresponding to the communications device, or any combination thereof. In particular embodiments, the processor coupled to the at least one memory is additionally to transmit a reliability metric, which qualifies the trust score, to the client computing resource. In particular embodiments, the processor coupled to the at least one memory is additionally to compute the reliability metric based at least in part on a measure of velocity or a measure of frequency with which the one or more subscriber identifiers were previously or subsequently assigned to the communications device by the communication services carrier. In particular embodiments, the processor coupled to the at least one memory is additionally to designate for monitoring one or more of the currently-assigned subscriber identifier and the one or more subscriber identifiers previously or subsequently assigned to the communications device, based at least in part on the obtained reliability metric being less than a threshold.

### BRIEF DESCRIPTION OF THE DRAWINGS

Claimed subject matter is particularly pointed out and distinctly claimed in the concluding portion of the specification. However, both as to organization and/or method of operation, features, and/or advantages thereof, it may best be understood by reference to the following detailed description if read with the accompanying drawings in which:

FIG. 1 is a diagram of a communications infrastructure that includes both wireless and wireline communications devices, according to various embodiments.

FIG. 2 is a diagram of a subscriber in possession of a communications device to facilitate interaction with a client computing resource and an authentication server, according to an embodiment.

FIG. 3 is a diagram showing components of a communication services provider network utilized in a system to perform linking of communications device subscriber identifiers for fraud detection, according to an embodiment.

FIG. 4A is a diagram showing use of a subscriber identifier of a communications device, in which a currently-assigned subscriber identifier is linked to other subscriber identifiers to assist in detection of potentially fraudulent activities, according to an embodiment.

FIG. 4B is a diagram showing currently-assigned subscriber identifiers along with previously and subsequently assigned subscriber identifiers to assist in detection of potentially fraudulent activities, according to an embodiment.

FIG. 5 shows a flowchart for a process of linking device subscriber identifiers for fraud detection, according to an embodiment.

FIG. 6 is a diagram showing a computing environment, according to an embodiment.

Reference is made in the following detailed description to the accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others, one or more aspects, properties, etc. may be omitted, such as for ease of discussion, or the like. Further, it is to be understood that other embodiments may be utilized. Furthermore, structural and/or other changes may be made without departing from claimed subject matter. References throughout this specification to “claimed subject matter'' refer to subject matter intended to be covered by one or more claims, or any portion thereof, and are not necessarily intended to refer to a complete claim set, to a particular combination of claim sets (e.g., method claims, apparatus claims, etc.), or to a particular claim.

### DETAILED DESCRIPTION

References throughout this specification to one implementation, an implementation, one embodiment, an embodiment, and/or the like means that a particular feature, structure, characteristic, and/or the like described in relation to a particular implementation and/or embodiment is included in at least one implementation and/or embodiment of claimed subject matter. Thus, appearances of such phrases in various places throughout this specification, are not necessarily intended to refer to the same implementation and/or embodiment or to any one particular implementation and/or embodiment. Furthermore, it is to be understood that particular features, structures, characteristics, and/or the like described, are capable of being combined in various ways in one or more implementations and/or embodiments and, therefore, are within intended claim scope. In general, for the specification of a patent application, these and other issues have a potential to vary in a particular context of usage. In other words, throughout the disclosure, particular context of description and/or usage provides guidance regarding reasonable inferences to be drawn; however, likewise, the term “in this context” in general without further qualification refers at least to the context of the present patent application.

As previously alluded to, devices that communicate electronically, such as wireless mobile communications devices, voice over Internet protocol (VoIP) communications devices, and devices representing the Internet of things (e.g., wireless sensors, wireless appliances, wireless industrial, commercial, and household machines, etc.) become increasingly popular. As these types of devices gain in popularity, a need to authenticate, verify, and/or validate such electronic communications devices also increases. Authentication of electronic communications devices, and/or users of such devices, may be especially beneficial in environments that may facilitate financial transactions utilizing wireless communications devices. Such transactions may involve completing applications for credit, obtaining loans, purchasing products and/or services, obtaining access to privileged content, completing and/or submitting loan applications, completing forms involved with applying for healthcare coverage (such as in connection with visiting a health provider's office), and/or engaging in other types of transactions via a communications device. In other environments, such as environments involving IOT devices, wireless communications devices may facilitate remote access to a wide variety of sensors, appliances, machines, and instruments, in which output signals from such devices may be utilized to drive numerous decision-making processes. To facilitate transactions involving communications devices, and/or to obtain signal outputs from trusted communications IOT devices, a subscriber co-located with, or otherwise affiliated with, a communications device may establish an identity. An identity may be established in connection with a communications device subscriber account with a cellular or mobile wireless communications services carrier, a VoIP services provider, or other type of communication services carrier. Establishing an account associated with a communications device, utilizing, for example, a subscriber identifier (e.g., a cellular telephone number, a universally unique identifier or UUID, etc.), may assist or facilitate an individual attempting to engage in an electronic or digital transaction to be authenticated, authorized, and/or verified prior to engaging in the transaction. In other instances, an account associated with a communications device may operate to provide access to output signals supplied by IOT sensors. In some instances, in view of the nature of electronic or digital transactions, such as in environments in which electronic or digital transactions can be initiated via a communications network at any time and at any location, it may be useful to quickly verify and/or authenticate an owner and/or a user of a communications device.

In a financial services environment, for example, authentication and/or verification of a subscriber operating, or at least co-located with, a communications device may be desirable in response to a client institution or organization (e.g., a financial institution, a brokerage, a healthcare provider, content provider, etc.) seeking to determine and/or prove the identity of a transacting party. In another example, such as in an IOT environment, authentication and/or verification of a communications device, or of a user of such devices, may be desirable as a means of ensuring such devices operate under the exclusive control of authorized and/or certain individuals. In particular embodiments, authorization and/or verification of a communications device or an IOT device may involve establishing a bind between an authenticating entity and a subscriber operating a communications. In such contexts, a subscriber identifier, may operate to establish a persistent, continuing, and objectively verifiable correspondence or affiliation between a communications device and a subscriber in possession of, or at least associated with, a particular communications device.

Thus, in a financial services environment, for example, a unique subscriber identifier may function to signify and/or identify a particular transacting party. In this context, the term “subscriber identifier” and/or similar terms refer to an identity that leverages a mobile communications device account relationship of a subscriber as a source of authentication and/or verification of a transacting party. Also in this context, the term “mobile subscriber device account” and/or similar terms refer to a mobile communication services provider account. The terms “communications device services provider,” “mobile communications device carrier,” “mobile communications device services provider,” “mobile network operator,” and “carrier” may be used interchangeably. Such entities may refer to a service provider of wired and/or wireless communication services, which may be provided to the public for a consideration, such as a monthly subscription fee. However, there are examples of carriers that do not correspond to mobile communications device services providers and/or mobile network operators. Such instances may include wireline services providers (for example, providers of services operating within the public switched telephone network or PSTN), which include wireline services for rotary-dial telephones and/or telephones utilizing, for example, dual tone multi-frequency (DTMF) signaling. In a given situation, particular context of usage should indicate if a term is being used in a general sense or in a narrower sense, such as referring to a mobile communications device services provider, wireline services provider, mobile paging services provider, and/or mobile network operator, for example.

Other aspects of verifying and/or authenticating a communications device (e.g., a mobile communications device, an IOT device, etc.) are also described in greater detail hereinbelow. For example, in an embodiment, verifying the identity and/or authenticating a subscriber, may bring about establishment of a bind between an individual and a mobile subscriber account. Further, a mobile subscriber account is merely an example approach toward establishing a correspondence between an individual and a communications device, and claimed subject matter is not intended to be limited to accounts established for mobile cellular communications devices and IOT devices. Rather, the term “account” or “subscriber account” in this context refers generally to a formal business arrangement between a provider of the account and an entity, a person, or other party seeking to obtain privileges associated with the account. Thus, the term “account” is intended to be broadly interpreted as an arrangement that may provide certain privileges. In this context, privileges may involve access to credit and/or funds (e.g., so as to facilitate the present or future purchase of goods or services), access to privileged content (e.g., such as premium sports, cinema, or other entertainment content), access to health records, access to financial records, access to financial and/or brokerage accounts, access to parameters and/or other types of signals transmitted by IOT devices, an ability to control and/or influence operation of IOT devices, and so forth. In this context, the term “privileged content” is intended to be interpreted broadly so as to encompass any type of content available exclusively to certain individuals and/or certain entities in response to supplying certain credentials to a bank or financial institution, an IOT device, a mobile communication services provider, and so forth.

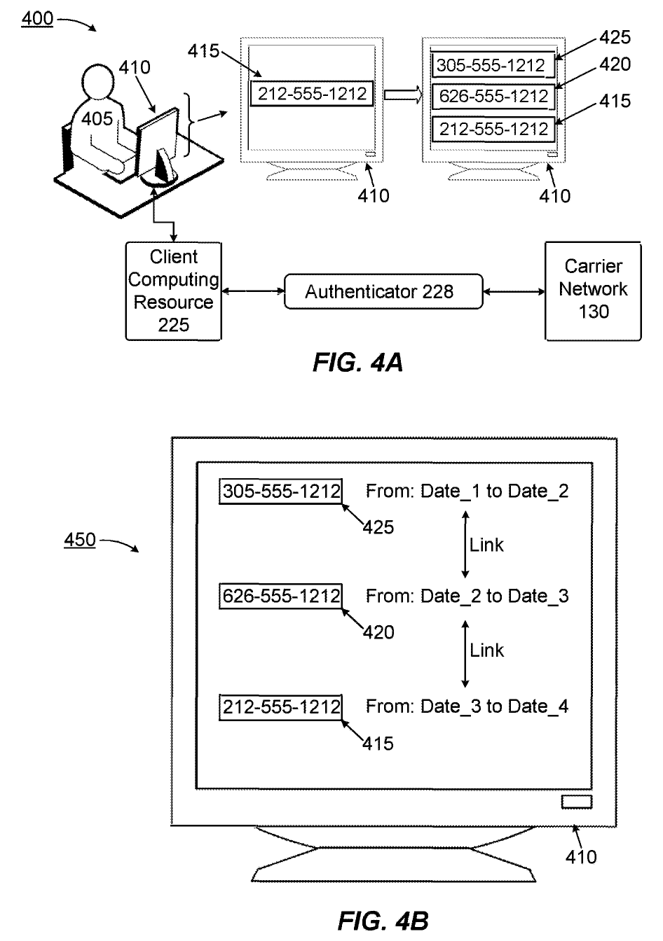

Likewise, an account may comprise various attributes. For example, in the context of a mobile cellular communications device (e.g., a mobile telephone), the term “subscriber identifier” refers to a unique descriptor associated with the account that defines certain aspects of the account. For example, in nonlimiting illustrations, a subscriber identifier may refer to (or may at least be associated with) a mobile telephone number, a mobile subscriber unique alias, or any other type of identifier utilized by, for example, a communication device services provider (e.g., a mobile network operator) to route incoming telephone calls to a specific mobile device. In some instances, a subscriber identifier may refer to a telephone number of a specific mobile device. Accordingly, a Mobile Station International Subscriber Directory Number (MSISDN) or at least a portion thereof, such as shown and described in relation to FIGS. 4A and 4B, may represent an example of a subscriber identifier, although claimed subject matter is not limited in this respect.

Individual communications devices may be identified by a communication device services provider utilizing device-specific identifiers stored within, for example, a subscriber identity module. For example, device-specific identifiers may include an International Mobile Equipment Identifier (IMEI), an Integrated Circuit Card Identification (ICC ID) Number, which corresponds to an 18-22 digit code that includes a subscriber identity module's country, home network, and one or more other numbers. It should be noted that claimed subject matter is intended to embrace other identifiers that may be utilized to identify or to correspond with a mobile billing account number/identifier.

In a communications environment that supports or facilitates electronic financial transactions, a subscriber associated or affiliated with a communications device may apply for an account, such as a credit account, for example, or may apply for any other type of account that imparts or confers particular privileges on the subscriber. In other instances, a subscriber co-located with a mobile device may attempt to engage in a financial transaction, for example, or may attempt to access privileged information/privileged content, just to name a few examples. In still other instances, a subscriber may wish to obtain output parameters from an IOT device or to supply configuration and/or control signals to the IOT device. In these and other instances, to obtain privileges, such as access to credit, access to privileged information (e.g., premium content streaming or other entertainment), to access output parameters from an IOT device, a mobile subscriber may be required to establish some type of credentials, such as via completion of an application (e.g., such as an application for an account), an application for credit, an application for an increase in credit, or may be required to make another type of formal request, which involves the subscriber supplying subscriber-specific parameters. Such subscriber-specific parameters may be utilized by an authenticator, for example, so as to verify and/or validate the real-world identity of the subscriber. However, as previously alluded to, it may be advantageous for the subscriber, and for the institution or service providing privileges to the subscriber, for example, to verify or prove that, indeed, the subscriber is co-located with, or otherwise affiliated with, a particular communications device. By proving affiliation of a subscriber with a particular communications device, an institution or a service may reduce the risk that an unscrupulous individual, for example, may access privileged information, which may enable unscrupulous individuals to penetrate an IOT network and/or to impersonate a particular (legitimate) individual. Such fraudulent behavior may be made possible by an unscrupulous individual stealing another subscriber's mobile phone or identity, or by way of obtaining sensitive information that enables the unscrupulous individual to impersonate another subscriber. In certain instances, impersonation of another subscriber may enable the unscrupulous individual to withdraw funds from a subscriber's account, illegally obtain physical access to a subscriber's home (e.g., such as by unlocking a door controlled by an IOT device), and so forth.

Thus, responsive to an unscrupulous individual successfully impersonating a particular subscriber, the unscrupulous individual may be allowed to successfully complete a financial transaction, such as obtaining funds, applying for credit, obtaining privileged content from a content provider, and so forth. In some instances, after fraudulently completing the financial transaction, the unscrupulous individual may quickly initiate a change to a subscriber identifier (such as a MSISDN or at least a portion thereof) utilized by a communications device services provider (e.g., a mobile network operator) used by the defrauded creditor, financial institution, etc., so as to avoid receiving incoming calls from defrauded parties. In some instances, the unscrupulous individual may initiate a change to a subscriber identifier in an attempt to impersonate a different individual and to repeat a fraudulent activity, such as applying for credit, obtaining funds, transferring funds, obtaining privileged content from a content provider, and so forth. In some instances, an unscrupulous individual may complete several changes to a subscriber identifier (e.g., a MSISDN or at least a portion thereof), such as by way of interacting with a mobile network operator, within a single day. Such high-frequency changes to a subscriber identifier may be indicative of an especially unscrupulous individual attempting to obtain credit, funds, or engage in other activities from various financial institutions following each change or modification to a subscriber identity associated with a communications device. In other instances, an especially unscrupulous individual may make modifications to a subscriber identifier with high velocity, via interaction with a mobile network operator, perhaps two or three times (or more) in a single day.

In some instances, an individual modification to a subscriber identifier, which involves interacting with a communication device services provider (e.g., a mobile network operator) may be indicative of a corresponding fraudulent activity involving a financial institution. Thus, it may be appreciated that responsive to an unscrupulous individual being allowed to modify a subscriber identifier (e.g., a MSISDN or at least a portion thereof) five times in a single day may represent five separate attempts to defraud a financial institution, obtain privileged content, obtain credit from one or more merchants, etc. Thus, it may also be appreciated that attempts to reduce the possibility of such fraudulent activities may be of benefit to financial institutions, content providers, and other institutions and entities. In addition to benefiting various institutions and entities, reducing the possibility of fraudulent activities may also benefit legitimate subscribers, by reducing instances of identity theft, credit card fraud, theft of financial assets, and so forth.

Accordingly, in particular embodiments, reducing possibilities of fraudulent use of a communications device by unscrupulous individuals impersonating the legitimate subscriber may be achieved by linking currently-assigned subscriber identifiers with subscriber identifiers previously assigned to the same device. Thus, in particular instances, responsive to a bank or other type of financial institution obtaining a subscriber identifier, the institution may contact an authentication or identity verification entity to determine whether a subscriber identity is linked to other subscriber identities previously or subsequently assigned to the same communications device. For example, responsive to a financial institution (e.g., a bank) obtaining a subscriber identifier in connection with a loan or credit application, the financial institution may contact an authenticator to determine if the obtained subscriber identifier has recently been utilized to perform a fraudulent or potentially fraudulent financial transaction. In addition, the authenticator may provide additional subscriber identifiers, such as those corresponding to identifiers previously assigned to the same communications device. In some instances, a financial institution may obtain a subscriber identifier that was perhaps previously used by an unscrupulous individual, which may allow the institution to obtain subscriber identifiers subsequently assigned to a particular communications device. Thus, it may be appreciated that responsive to a fraud detection unit, for example, of a financial institution submitting a first subscriber identifier to an authenticator, the authenticator may provide a listing of previously-assigned and/or subsequently-assigned subscriber identifiers utilized to route calls by mobile network operator to a particular communications device. Such forward and backward checking of a chain of subscriber identifiers utilized by a mobile network operator to route calls to a particular communications device, a number of fraudulent transactions may be detected.

In addition to detection of fraudulent financial transactions, currently-assigned subscriber identifiers, as well as previously-assigned and subsequently-assigned identifiers may forestall completion subsequent fraudulent financial transactions. For example, responsive to a fraud detection unit of a financial institution obtaining a subscriber identifier for a potential credit applicant, the financial institution may interact with an authenticator to determine if the obtained subscriber identifier is linked to a subscriber identifier previously-assigned to a communications device involved in a fraudulent transaction. The fraud detection unit can then terminate a credit approval process, thereby preventing a current attempt by an unscrupulous individual to fraudulently obtain credit. A fraud detection unit of a financial institution may utilize previously-assigned and subsequently-assigned subscriber identifiers corresponding to a particular communications device for other reasons, and claimed subject matter is not limited in this respect.

Further, responsive to an authenticator receiving a report, such as a report indicating that a particular subscriber identifier has been involved in a fraudulent transaction, the authenticator may provide a service to other, potentially similar financial institutions so as to notify such institutions that a particular identifier has been involved in a fraudulent transaction. Consequently, responsive to the similar financial institution, for example, obtaining the subscriber identifier involved in the previous fraudulent transaction, the financial institution may obtain a record of all previously-assigned and subsequently-assigned subscriber linked to the identifier involved in the previous fraudulent transaction. Thus, a plurality of financial institutions, and their clients, may benefit from knowledge that a subscriber identifier, which may be linked to a subscriber identifier of a current applicant, may indicate that a present applicant is, potentially, not to be trusted. An authenticator may provide one or more subscriber identifiers involved in financial transactions, which may be disseminated to other institutions free of charge or for a fee, for other reasons, and claimed subject matter is not limited in this respect.

In particular embodiments, one or more modifications to a subscriber identifier (e.g., a MSISDN or at least a portion thereof) may be reflected in a reliability metric, which may be utilized as a qualifier for a trust score, which may be assigned to a particular communications device co-located with a subscriber. For example, responsive to a subscriber having owned a particular communications device for an extended period of time (e.g., phone tenure), along with other parameters that enhance or degrade the trust score of a subscriber's communications device, an authenticator may assign a particular trust score to a subscriber. However, in at least some embodiments, responsive to detection of a recent modification to a subscriber identifier, an authenticator may additionally assign a particular a reliability metric. For example, in response to an authenticator determining that a currently-assigned subscriber identifier has recently been modified one or more times, the subscriber may be assigned a reliability metric to indicate a degraded measure of the reliability of the trust score may be assigned. Conversely, in response to an authenticator determining that a currently-assigned subscriber identifier has not undergone any recent modifications, an enhanced measure of reliability of the trust score may be assigned. In some embodiments, an increased frequency and/or velocity of such modifications to the subscriber identifier may give rise to a decreased reliability metric.

In particular embodiments, in response to a reliability metric assigned to a particular subscriber identifier falling below a predetermined lower threshold, an authenticator may designate the subscriber for increased monitoring. Such increased monitoring may provide an additional level of protection of legitimate subscribers and institutions by shortening the time that an institution may consume in responding to detection of a fraudulent transaction. Further, in particular embodiments that relate to use of a communications device to obtain or to access input signals and/or output signals of IOT devices, linking of communication device subscriber identifiers for fraud detection may operate to enhance the integrity of such signal inputs and/or signal outputs.

Although the discussion that follow relate to any type of account, in nonlimiting illustrations, accounts corresponding to communications devices may be used for illustration. However, it is understood that claimed subject matter is intended to not be limited to examples provided primarily for purposes of illustration, since such examples may be oversimplified for purposes of comprehension, for example.

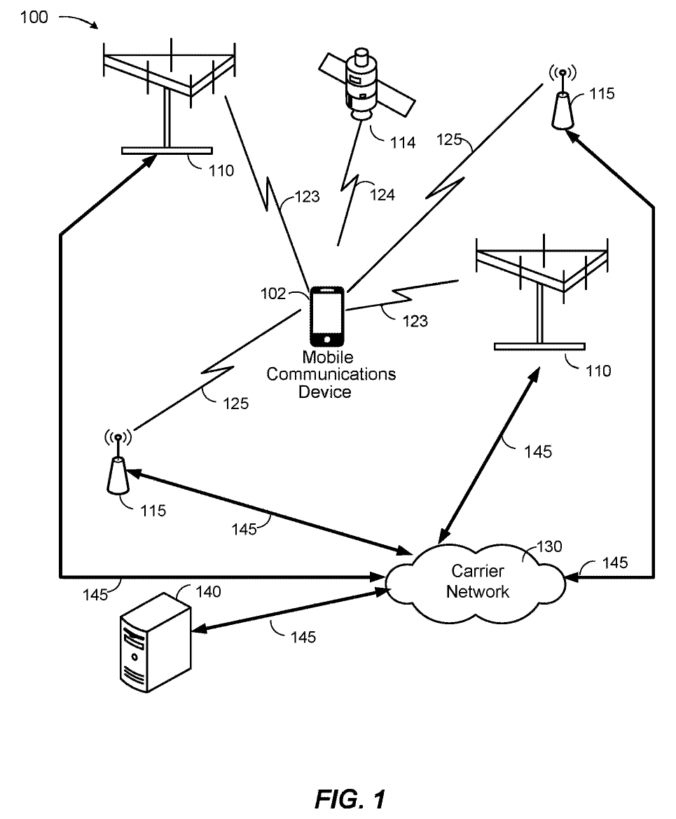

In FIG. 1, corresponding to embodiment 100, communications device 102 corresponds to a device designed primarily to conduct communications via wireless or wireline means, such as to provide mobile wireless telephone communications, texting, web browsing, and so forth. Communications device 102 may additionally correspond to an IOT device, which may comprise any of a wide variety of devices, such as home automation devices (e.g., garage door openers, door locks, thermostats, etc.), Wireless Fidelity (Wi-Fi) enabled large appliances (e.g., washing machines, dryers, refrigerators, etc.), entertainment systems and components (e.g., televisions, stereos, etc.), wearable devices (e.g., smart watches, wearable insulin pumps, etc.), control devices (e.g., air conditioners, heaters, etc.), moisture sensors, humidity sensors, and a myriad of other control devices, sensing devices, monitoring devices, and claimed subject matter is not limited in this respect.

In the embodiment of FIG. 1, communications device 102 may transmit radio signals to, and receive radio signals from, a wireless communications network. In an example, communications device 102 may communicate with a cellular communications network by transmitting wireless signals to, and/or receiving wireless signals from, a cellular transceiver 110, which may comprise a wireless base transceiver subsystem, a Node B or an evolved NodeB (eNodeB), over wireless communication link 123. Similarly, communications device 102 may transmit wireless signals to, and/or receive wireless signals from, local transceiver 115 over wireless communication link 125. A local transceiver 115 may comprise an access point (AP), femtocell, Home Base Station, small cell base station, Home Node B (HNB) or Home eNodeB (HeNB) and may provide access to a wireless local area network (WLAN, e.g., IEEE 802.11 network), a wireless personal area network (WPAN, e.g., Bluetooth® network) or a cellular network (e.g. an LTE network or other wireless wide area network, such as those discussed herein). Of course, it should be understood that these are merely examples of networks that may communicate with a mobile device over a wireless link, and claimed subject matter is not limited in this respect. In particular embodiments, cellular transceiver 110, local transceiver 115, satellite 114, and PSTN 150 represent touchpoints, which facilitate interaction between communications device 102 and communication services provider network 130.

Examples of network technologies that may support wireless communication link 123 are GSM, Code Division Multiple Access (CDMA), Wideband CDMA (WCDMA), Long Term Evolution LTE), High Rate Packet Data (HRPD). GSM, WCDMA and LTE are technologies defined by 3GPP. CDMA and HRPD are technologies defined by the 3rd Generation Partnership Project 2 (3GPP2). WCDMA is also part of the Universal Mobile Telecommunications System (UMTS) and may be supported by an HNB. Cellular transceivers 110 may comprise deployments of equipment providing subscriber access to a wireless telecommunication network for a service (e.g., under a service contract). In the embodiment of FIG. 1, a cellular transceiver 110 may perform functions of a cellular base station in servicing subscriber devices within a cell determined based, at least in part, on a range at which the cellular transceiver 110 is capable of providing access service. Examples of radio technologies that may support wireless communication link 125 are IEEE 802.11, BT and LTE.

In a particular implementation, cellular transceiver 110 and local transceiver 115 may communicate with server 140, such as by way of communication services provider network 130 via communication links 145. Here, communication services provider network 130 may comprise any combination of wired or wireless links and may include cellular transceiver 110 and/or local transceiver 115 and/or server 140. In a particular implementation, communication services provider network 130 may comprise Internet Protocol (IP) or other infrastructure capable of facilitating communication between communications device 102 at a call source and server 140 through local transceiver 115 or cellular transceiver 110. In an embodiment, communication services provider network 130 may also facilitate communication between communications device 102, server 140 and a PSTN 150, for example through communications link 160. In another implementation, communication services provider network 130 may comprise a cellular communication network infrastructure such as, for example, a base station controller or packet based or circuit based switching center (not shown) to facilitate mobile cellular communication with communications device 102. In a particular implementation, communication services provider network 130 may comprise local area network (LAN) elements such as WiFi APs, routers and bridges and may, in such an instance, comprise links to gateway elements that provide access to wide area networks such as the Internet. In other implementations, communication services provider network 130 may comprise a LAN and may or may not involve access to a wide area network but may not provide any such access (if supported) to communications device 102. In some implementations, communication services provider network 130 may comprise multiple networks (e.g., one or more wireless networks and/or the Internet). In one implementation, communication services provider network 130 may include one or more serving gateways or Packet Data Network gateways. In addition, one or more of server 140 may comprise an E-SMLC, a Secure User Plane Location (SUPL) Location Platform (SLP), a SUPL Location Center (SLC), a SUPL Positioning Center (SPC), a Position Determining Entity (PDE) and/or a gateway mobile location center (GMLC), each of which may connect to one or more location retrieval functions (LRFs) and/or mobility management entities (MMEs) of network 130.

In particular embodiments, communications between communications device 102 and cellular transceiver 110, satellite 114, local transceiver 115, and so forth may occur utilizing signals communicated across wireless communications channels. Accordingly, the term “signal” may refer to communications utilizing propagation of electromagnetic waves across wireless communications channels. Signals may be modulated to convey messages utilizing one or more techniques such as amplitude modulation, frequency modulation, binary phase shift keying (BPSK), quaternary phase shift keying (QPSK) along with numerous other modulation techniques, and claimed subject matter is not limited in this respect. Accordingly, as used herein, the term “messages” refers to parameters, such as binary signal states, which may be encoded in one or more signals using one or more of the above-identified modulation techniques.

In particular implementations, and as discussed below, communications device 102 may comprise circuitry and processing resources capable of obtaining location related measurements (e.g. for signals received from GPS or other Satellite Positioning System (SPS) satellites 114), cellular transceiver 110 or local transceiver 115 and possibly computing a position fix or estimated location of communications device 102 based on these location related measurements. In some implementations, location related measurements obtained by communications device 102 may be transferred to a location server such as an enhanced serving mobile location center (E-SMLC) or SUPL location platform (SLP) (e.g. which may comprise a server, such as server 140) after which the location server may estimate or determine an estimated location for communications device 102 based on the measurements. In the presently illustrated example, location related measurements obtained by communications device 102 may include measurements of signals 124 received from satellites belonging to an SPS or Global Navigation Satellite System (GNSS) such as GPS, GLONASS, Galileo or Beidou and/or may include measurements of signals (such as 123 and/or 125) received from terrestrial transmitters fixed at known locations (e.g., such as cellular transceiver 110).

Communications device 102 or a separate location server may obtain a location estimate for communications device 102 based on location related measurements using any one of several position methods such as, for example, GNSS, Assisted GNSS (A-GNSS), Advanced Forward Link Trilateration (AFLT), Observed Time Difference Of Arrival (OTDOA) or Enhanced Cell ID (E-CID) or combinations thereof. In some of these techniques (e.g. A-GNSS, AFLT and OTDOA), pseudoranges or timing differences may be measured at communications device 102 relative to three or more terrestrial transmitters fixed at known locations or relative to four or more satellites with accurately known orbital data, or combinations thereof, based at least in part, on pilots, positioning reference signals (PRS) or other positioning related signals transmitted by the transmitters or satellites and received at communications device 102. Here, server 140 may be capable of providing positioning assistance data to communications device 102 including, for example, information regarding signals to be measured (e.g., signal timing), locations and identities of terrestrial transmitters and/or signal, timing and orbital information for GNSS satellites to facilitate positioning techniques such as A-GNSS, AFLT, OTDOA and E-CID. For example, server 140 may comprise an almanac to indicate locations and identities of cellular transceivers and/or local transceivers in a particular region or regions such as a particular venue, and may provide information descriptive of signals transmitted by a cellular base station or AP such as transmission power and signal timing. In the case of E-CID, communications device 102 may obtain measurements of signal strengths for signals received from cellular transceiver 110 and/or local transceiver 115 and/or may obtain a round trip signal propagation time (RTT) between communications device 102 and a cellular transceiver 110 or local transceiver 115. A communications device 102 may use these measurements together with assistance data (e.g. terrestrial almanac data or GNSS satellite data such as GNSS Almanac and/or GNSS Ephemeris information) received from server 140 to determine a location estimate for communications device 102 or may transfer the measurements to server 140 to perform the same determination. A call from communications device 102 may be routed, based on the location of communications device 102, and connected to PSTN 150, for example, via wireless communication link 123 and communications link 160.

A mobile device at a call source (e.g., communications device 102 of FIG. 1) may be referred to by any name corresponding to a cellphone, smartphone, laptop, tablet, PDA, tracking device or some other portable or movable device. Typically, though not necessarily, a mobile device may support wireless communication such as using GSM, WCDMA, LTE, CDMA, HRPD, WiFi, BT, WiMax, etc. A mobile device may also support wireless communication using a wireless LAN (WLAN), DSL or packet cable for example. A mobile device may comprise a single entity or may comprise multiple entities such as in a personal area network where a user may employ audio, video and/or data 1/0 devices and/or body sensors and a separate wireline or wireless modem. An estimate of a location of a mobile device (e.g., communications device 102) may be referred to as a location, location estimate, location fix, fix, position, position estimate or position fix, and may be geographic, thus providing location coordinates for the mobile device (e.g., latitude and longitude) which may or may not include an altitude component (e.g., height above sea level, height above or depth below ground level, floor level or basement level).

Responsive to communications device 102 comprising a mobile cellular communications device, device 102 may comprise an embedded sensor suite which may, for example, include inertial sensors and environment sensors. Inertial sensors of communications device 102 may comprise, for example accelerometers (e.g., collectively responding to acceleration of communications device 102 in and x-direction, a y-direction, and a z-direction). Communications device 102 may further include one or more gyroscopes or one or more magnetometers (e.g., to support one or more compass applications). Environment sensors of communications device 102 may comprise, for example, temperature sensors, barometric pressure sensors, ambient light sensors, camera imagers, microphones, just to name few examples. Sensors of communications device 102 may generate analog or digital signals that may be stored in utilizing one or more memory locations internal to device 102 in support of one or more applications such as, for example, applications collecting or obtaining biometric attributes of a user (e.g., a subscriber) of communications device 102.

The architecture of the cellular communications network described in relation to FIG. 1 may comprise a generic architecture that is capable of accommodating a variety of outdoor and indoor location solutions including the standard SUPL user plane location solution defined by the Open Mobile Alliance (OMA) and standard control plane location solutions defined by 3GPP and 3GPP2. For example, server 140 may function as (i) a SUPL location platform to support the SUPL location solution, (ii) an E-SMLC to support the 3GPP control plane location solution with LTE access on wireless communication link 123 or 125, or (iii) a Standalone Serving Mobile Location Center (SAS) to support the 3GPP Control Plane Location solution for UMTS.

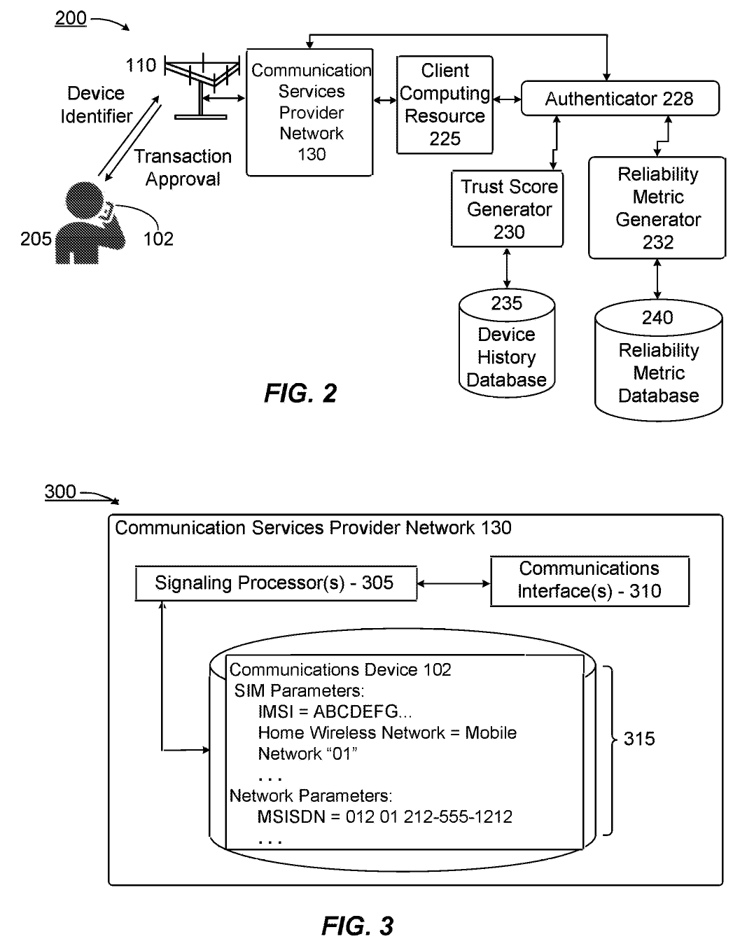

In view of the communications infrastructure as shown and described in reference to FIG. 1, more particular embodiments directed toward linking of communications device subscriber identifiers for fraud detection are described. Thus, in embodiment 200 depicted in FIG. 2, communications device 102 is shown interacting with client computing resource 225 and authenticator 228. In FIG. 2, mobile subscriber 205 and/or communications device 102 may be located at any point within communications range of cellular transceiver 110. As shown in FIG. 2, communications device 102 may communicate with client computing resource 225 via communication services provider network 130 and via a wireless communications channel between the communications device and cellular transceiver 110. It should be noted, however, that claimed subject matter is not limited exclusively to wireless communications between communications device 102 and cellular transceiver 110. For example, in particular embodiments, communications device 102 may communicate with client computing resource 225 by way of one or more intervening Wi-Fi networks or by way of wireline telephone services (e.g., the public switched telephone network).

Subscriber 205, utilizing communications device 102, may attempt to engage in a financial transaction via client computing resource 225. Client computing resource 225 may represent or signify a bank (or other type of financial institution), a real estate title company, a healthcare provider, a merchant (e.g., a department store), a content provider, or any other type of entity that may, at least from time to time, require verification, authentication, and/or auditing of communications device 102 prior to allowing a transaction to take place. In an alternative embodiment, communications device 102 may represent an IOT device, which may operate to transmit output signals representing, for example, sensor measurements. Sensor measurements may be utilized by a client computing resource, which may facilitate decision-making processes other than those of a financial nature, such as to support processes involving, for example, other types of IOT devices.

Subscriber 205 may operate communications device 102 to initiate a transaction involving client computing resource 225. In response to subscriber 205 attempting to initiate a transaction, client computing resource 225 may communicate with authenticator 228, which may operate to authenticate, verify, and/or audit subscriber 205 operating communications device 102. In the embodiment of FIG. 2, authentication, verification, and/or auditing of subscriber 205 may include authenticator 228 accessing trust score generator 230. Trust score generator 230 may access device history database 235, which may store historical records of deterministic events with respect to communications device 102, so as to obtain a trustworthiness metric or a trust score (which may be used interchangeably). Such records may represent events that may be regarded by client computing resource 225 as representing particular levels of trustworthiness of subscriber 205. In particular embodiments, client computing resource 225 may generate a trust score of subscriber 205 via examination of porting records, which may relate to how often subscriber 205 has ported communications device 102, such as to obtain a new subscriber identifier (e.g., mobile telephone number). Client computing resource 225 may also generate a trust score of subscriber 205 via examining records related to whether subscriber 205 has recently removed/replaced a SIM or eSIM of a communications device. Client computing resource 225 may generate a trust score of subscriber 205 via examining occurrences of password resets, such as indicated via transmission of one-time passwords to communications device 102. Client computing resource 225 may generate a trust score of subscriber 205 via examining tenure of communications device 102, which may relate to a duration that subscriber 205 has owned, operated, or has otherwise been affiliated with device 102. It should be noted that claimed subject matter is intended to embrace additional contributors to a trust score or trust score, virtually without limitation.

In the embodiment of FIG. 2, prior to allowing subscriber 205 to engage in a financial transaction via client computing resource 225, authenticator 228 may establish or form a secure channel between itself and communications device 102. Thus, as previously alluded to, authenticator 228 may initiate a browser-based Internet session between the authenticator and the communications device. In particular embodiments, in response to communications device 102 transmitting a subscriber identifier (e.g., a mobile telephone number) authenticator 228 may generate and transmit a tailored resource locator (e.g., a specially formulated URL), which may be conveyed to communications device 102 via client computing resource 225, network 130, and cellular transceiver 110. In response to obtaining the URL generated by authenticator 228, communications device 102 may be directed to initiate a browser-based Internet session directly with authenticator 228.

During a browser-based session between authenticator 228 and communications device 102, authenticator 228 may authenticate and/or validate communications device 102. Thus, in addition to authenticator 228 accessing trust score generator 230, which may obtain device history parameters from database 235, authenticator 228 may additionally access reliability metric generator 232. Reliability metric generator 232 may, in turn, obtain parameters from reliability metric database 240. In the embodiment of FIG. 2, authenticator 228 may analyze events related to changes to a subscriber identifier (e.g., a MSISDN or at least a portion thereof) to determine if a subscriber has made changes to the subscriber identifier such as in a predetermined period of time. For example, as noted previously herein, one or more modifications to a subscriber identifier (e.g., a MSISDN or at least a portion thereof) may be reflected in a reliability metric, which may be utilized as a qualifier for the trust score, which may be assigned to a particular communications device co-located with a subscriber.

For example in at least some embodiments, responsive to detection of a recent modification to a subscriber identifier, an authenticator may additionally assign a particular a reliability metric. For example, in an embodiment, in response to an authenticator determining that a currently-assigned subscriber identifier has recently been modified one or more times, the reliability metric generator 232 to indicate a degraded measure of the reliability of a trust score may be assigned. Conversely, in response to an authenticator determining that a currently-assigned subscriber identifier has not undergone any recent modifications, an increased reliability metric of the trust score may be assigned. In some embodiments, an increased frequency and/or velocity of such modifications to the subscriber identifier may give rise to a decreased reliability metric. In particular embodiments, to bring about a reliability metric generated by reliability metric generator 232, authenticator 228 may query communication services provider network 130, so as to obtain a record of, for example, subscriber-initiated changes to a subscriber identifier. As noted hereinabove, an unscrupulous individual may successfully impersonate a legitimate subscriber by modifying a subscriber identifier (e.g., a MSISDN or at least a portion thereof) associated with a communications device owned, or at least affiliated with, the legitimate subscriber. Such impersonation may allow the unscrupulous individual to engage in a financial transaction, such as obtaining funds, applying for credit, obtaining privileged content from a content provider, and so forth in the name of the legitimate subscriber.

However, in the architecture of embodiment 200, responsive to authenticator 228 obtaining a record of events relating to subscriber-initiated changes to a subscriber identifier (e.g., a MSISDN or at least a portion thereof), authenticator 228 may access reliability metric generator 232. Authenticator 228 may communicate the record of events relating to subscriber-initiated changes to subscriber identifier generator 232. Responsive to obtaining a record of changes to a subscriber identifier, reliability metric generator 232 may generate a particular reliability metric. In particular embodiments, reliability metric generator 232 may utilize past changes to a subscriber identifier relative to a particular subscriber's historical tendency to modify the subscriber identifier. For example, if subscriber 205 corresponds to a celebrity or other notable figure, such a subscriber may, as a matter of normal practice, modify his or her subscriber identify, perhaps once per year, or at any other suitable interval. In such an instance, reliability metric generator 232 may neither increase nor decrease a reliability metric. However, in other instances, such as instances in which subscriber 205 has seldom or even never modified a subscriber identifier, detection of two or more changes, for example, to a subscriber identifier in a single six-month period may give rise to reliability metric generator 232 decreasing the reliability metric assigned to the subscriber. In particular embodiments, large deviations from a subscriber's normal practice of modifying his or her subscriber identifier (e.g., a MSISDN or at least a portion thereof) may bring about greater decreases in a reliability metric assigned to the subscriber. In particular embodiments, reliability metric generator 232 may take into consideration the number of changes made to the subscriber identifier, a frequency of changes to the subscriber identifier (e.g., one change per month, two changes per month, three changes per week, and so forth). Reliability metric generator may further take into consideration a velocity of changes to the subscriber identifier, such as two changes in a single hour, three changes in a single day, four changes in a single week, etc.

In particular embodiments, responsive to authenticator 228 communicating a trust score (e.g., generated by trust score generator 230) and a reliability metric (e.g., generated by reliability metric generator 232) to client computing resource 225, the client computing resource may limit an amount of the financial transaction. Such limitations to financial transactions may accord with business rules and/or business logic of the institution. For example, responsive to a particular subscriber having a relatively high trust score and a relatively low reliability metric, a client institution (e.g., a bank, a brokerage, a department store or other type of merchant) may allow the subscriber to engage in transactions of less than a particular monetary amount. In another example, responsive to a particular subscriber having a relatively high trust score and a relatively high reliability metric, a client institution may allow the subscriber to engage in transactions of a greater monetary amount. Similarly, if a client computing resource is utilized in the context of controlling, for example, IOT devices, responsive to a particular subscriber having a relatively high trust score and a relatively low reliability metric, the IOT device may allow the subscriber to perform only certain changes to input signals or to access only certain output signals. Thus, for example, a subscriber may be allowed only to modify certain control and/or configuration settings or may be allowed to receive only certain types of output signals from the IOT device. In another example, again, in the context of a subscriber being permit to access control and/or configuration settings of an IOT device, a subscriber having a relatively high trust score and a relatively high reliability metric may be allowed to perform any desired changes to control and/or configuration settings and/or to receive all types of output signals from the IOT device.

Thus, it may be appreciated that in particular embodiments, such as that of FIG. 2, a subscriber may initiate a transaction with a client computing resource operating under the control and/or influence of a financial institution. Such communication may occur via one or more intervening components of a wireless communications carrier network. In response to the initiation of the transaction, a client computing resource may communicate with an authenticator, which may obtain records of a subscriber identifier corresponding to (or associated with) the subscriber. Such records may pertain to a trust score or trust metric of the subscriber as well as a reliability metric, which operates as a qualifier of the trust score or trust metric. A trust score may be based, at least in part, on deterministic events with respect to the communications device co-located with the subscriber. A reliability metric may be based, at least in part, on a number of times that the subscriber has modified his or her subscriber identifier (e.g., a MSISDN or at least a portion thereof). Changes to the subscriber identifier may be determined by the authenticator, cooperating with a carrier network, in which the carrier network may report changes to subscriber identifiers. The authenticator may determine that changes have been made to the subscriber identifier in response to, or in advance of, the subscriber initiating the transaction. The authenticator may determine that a currently-assigned subscriber identifier is linked to one or more previously-assigned subscriber identifiers and/or to one or more subsequently-assigned subscriber identifiers. Thus, an authenticator may be capable of providing a trust score, and a reliability metric (based, at least in part, on detection of one or more links between or among the current, previous, and/or subsequent subscriber identifiers. Detection of such linkage may operate to qualify the trust score. In turn, the authenticator report such linkage to the client computing resource, which may alert the financial institution of potential fraud involving the previously-assigned and/or the subsequently-assigned subscriber identifier. This may allow the client computing resource to identify sources of potential fraud by unscrupulous individuals.

FIG. 3 is a diagram showing various components of communication services provider network 130, which is utilized in a system to perform linking of communications device subscriber identifiers for fraud detection, according to an embodiment 300. In embodiment 300, communication services provider network 130 comprises signaling processor 305, which may be coupled to communication interfaces(s) 310. Communication interfaces(s) 310 may facilitate communications among other network elements of communication services provider network 130 (not shown in FIG. 3). Signaling processor 305 is shown as communicating with subscriber database 315, which comprises parameters relevant to a particular communications device, such as communications device 102. Thus, for example, subscriber database 315 may include parameters such as parameters stored on the SIM of the communications device. Such parameters may include the communication device's international mobile subscriber identity (IMSI), such as ABCDEFG, an indication of the home wireless network assigned to the device, such as mobile network “01,” as well as other parameters stored perhaps on the SIM of communications device 102 or able to be derived from parameters stored on the SIM of the communications device. Thus, in the embodiment of FIG. 3, communication services provider network 130 may correspond to home wireless network 01.

Thus, in an implementation, in response to a subscriber making an outgoing call, communications device 102 may transmit an international mobile subscriber identity (e.g., ABCDEFG) via a cellular resource (e.g., 110), which may be received and processed by signaling processor 305. In turn, signaling processor 305 may access subscriber database 315 to facilitate matching of the transmitted IMSI with the MSISDN assigned by communication services provider network 130. Signaling processor 305 may then initiate a call set up within communication services provider network 130, which may include establishing one or more communication links within the carrier network so as to couple signals originating from communications device 102 to a destination device. In the embodiment of FIG. 3, the destination device may comprise a client computing resource, such as client computing resource 225. In the embodiment shown in FIG. 3, responsive to connection of a telephone call between communications device 102 and client computing resource 225, the client computing resource may receive, process, and display at least a portion of the subscriber identifier, such as 212-555-1212. Accordingly, in one possible example within the context of the embodiment of FIG. 3, a change of the subscriber identifier 212-555-1212 to 305-555-1212 can be implemented via a change to the MSISDN stored within subscriber database 315.

FIG. 4A is a diagram showing use of a subscriber identifier of a communications device, in which a currently-assigned subscriber identifier is linked to other subscriber identifiers, to assist in detection of potentially fraudulent activities, according to an embodiment 400. In the embodiment of FIG. 4A, agent 405 may be affiliated with (e.g., may be an employee of) a bank, financial institution, healthcare provider, provider of premium content, etc. Agent 405 Is shown viewing computer display 410, may include an interface to communicate with authenticator 228. Authenticator 220 a include an interface that allows communication to and from client computing resource 225. Client computing resource 225 may include an interface to communicate with communication services provider network 130. Thus, responsive to agent 405 obtaining subscriber identifier 415 (e.g., 212-555-1212), agent 405 may submit a subscriber identifier to authenticator 228. In turn, authenticator 228 may request any previously-assigned subscriber identifiers corresponding to the same IMSI (e.g., ABCDEFG).

Responsive to agent 405 obtaining a subscriber identifier (e.g., at least a portion of a MSISDN) that corresponds to communications device 102, agent 405 may determine that a current subscriber identifier is linked to previously-assigned and/or subsequently-assigned subscriber identifiers. Thus, in the example of FIG. 4A, agent 405 may determine that currently-assigned subscriber identifier 415 (222-555-1212) corresponds to a communications device that had previously been assigned subscriber identifier 420 (626-555-1212). Agent 405 may additionally determine that previously-assigned subscriber identifier 420 (626-555-1212) was previously assigned subscriber identifier 425 (305-555-1212). Accordingly, agent 405 may be capable of determining that a currently-assigned subscriber identifier is linked to one or more previously-assigned subscriber identifiers. Further, responsive to identifying that previously-assigned subscriber identifiers 420 and/or 425 (626-555-1212 and/or 305-555-1212) were previously utilized to perform one or more fraudulent transactions, agent 405 may identify an initiated and/or pending transaction (e.g., a transaction involving a communications device 102 having the subscriber identifier 212-555-1212) as also being potentially fraudulent. Agent 405 may, in turn, elect to terminate the pending transaction, or at least designate the pending transaction for further review.

In another embodiment, responsive to agent 405 receiving a subscriber identifier corresponding to a subscriber's currently-assigned subscriber identifier 415 (212-555-1212) having been potentially engaged in a fraudulent transaction, agent 405 may additionally be capable of designating one or more linked (e.g., previously-assigned subscriber identifiers such as 420 and 425) as being potentially fraudulent. Thus, agent 405 may designate the previously-assigned subscriber identifiers as being indicative of potentially fraudulent transactions. Consequently, agent 405 may indicate that one or more of the previously-assigned identifiers should be scrutinized for potentially fraudulent activities. Thus, responsive to one or more previously-assigned identifiers 420, 425, etc., as being utilized to initiate a fraudulent financial transaction, for example, client computing resource 225 may notify agent 405 so that the agent can act to mitigate or forestall a pending fraudulent transaction. In another embodiment, responsive to detection of one or more of subscriber identifiers 420, 415, and 425, as being in involved in fraudulent activities, any subsequently-assigned identifiers (e.g., being linked by the same IMSI) can also be designated as being suspicious and/or potentially fraudulent.

FIG. 4B is a diagram showing currently-assigned subscriber identifiers along with previously-and subsequently-assigned subscriber identifiers to assist in detection of potentially fraudulent activities, according to an embodiment 450. In FIG. 4B, previously-assigned subscriber identifier 425 is indicated on computer display 410 as having been assigned (e.g., by a communication services provider) to a particular communications device from date_1 to date_2. Similarly, previously-assigned subscriber identifier 420 is indicated as having been assigned to the particular communications device from date_2 to date_3. Currently-assigned subscriber identifier 415 is indicated as having been assigned to the particular communications device from date_3 to date_4. As indicated, subscriber identifiers 425, 420, and 415 are all linked via the IMSI of the particular communications device. Thus, detection of any one of identifiers 415, 420, 425, or any other subscriber identifier that may be linked to any of subscriber identifiers 415, 420, and 425, indicated as being currently involved, or having been involved, in a fraudulent transaction may bring about identifying other subscriber identifiers as potentially also having been involved in fraudulent activities.

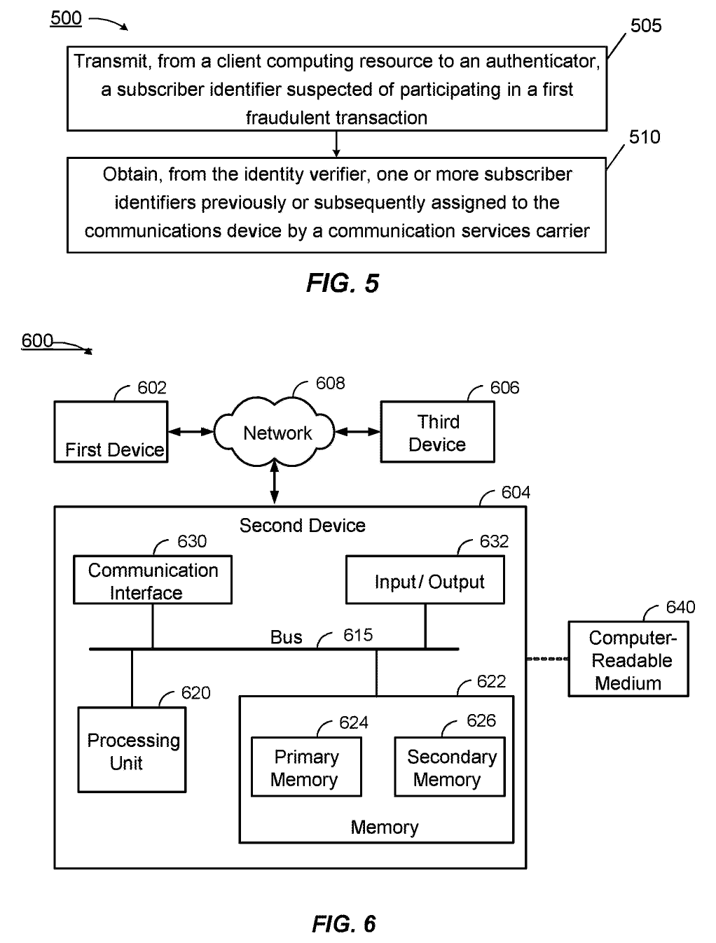

FIG. 5 shows a flowchart for a process of linking device subscriber identifiers for fraud detection, according to an embodiment. It should be noted that the disclosed embodiments, such as the embodiment of FIG. 5, are intended to embrace numerous variations, including methods that may include actions in addition to those depicted in the figures, actions performed in an order different than those depicted in the figures, as well as methods including fewer steps than those depicted. The embodiment of FIG. 5 may begin at 505, which may include transmitting, such as from a client computing resource to an authenticator, a subscriber identifier (e.g., at least a portion of a MSISDN) suspected of participating in a first fraudulent transaction. The method may continue at 510, which may include obtaining, from the identity verifier, one or more subscriber identifiers previously or subsequently assigned to the communications device by a communication services carrier.

FIG. 6 is a diagram showing a computing environment, according to an embodiment 600. In the embodiment of FIG. 6, first and third devices 602 and 606 may be capable of rendering a graphical user interface (GUI) for a network device, such as server device 140 of FIG. 1, so that a subscriber utilizing a communications device (e.g., a mobile cellular communications device, an IOT device, etc.) may engage in system use. Device 604 may potentially serve a similar function in this illustration. Likewise, in FIG. 6, computing device 602 ('first device' in FIG. 6) may interface with computing device 604 ('second device' in FIG. 6), which may, for example, also comprise features of a client computing resource and/or a server computing device, in an embodiment. Processor (e.g., processing device) 620 and memory 622, which may comprise primary memory 624 and secondary memory 626, may communicate by way of a communication interface 630, for example. The term “computing device,” or “computing resource” in the context of the present patent application, refers to a system and/or a device, such as a computing apparatus, which includes a capability to process (e.g., perform computations) and/or store digital content, such as electronic files, electronic documents, measurements, text, images, video, audio, etc. in the form of signals and/or states. Thus, a computing device, in the context of the present patent application, may comprise hardware, software, firmware, or any combination thereof (other than software per se). Computing device 604, as depicted in FIG. 6, is merely one example, and claimed subject matter is not limited in scope to this particular example.

In FIG. 6, computing device 602 may provide one or more sources of executable computer instructions in the form of physical states and/or signals (e.g., stored in memory states), for example. Computing device 602 may communicate with computing device 604 by way of a network connection, such as via network 608, for example. As previously mentioned, a connection, while physical, may be virtual while not necessarily being tangible. Although computing device 604 of FIG. 6 shows various tangible, physical components, claimed subject matter is not limited to a computing devices having only these tangible components as other implementations and/or embodiments may include alternative arrangements that may comprise additional tangible components or fewer tangible components, for example, that function differently while achieving similar results. Rather, examples are provided merely as illustrations. It is not intended that claimed subject matter be limited in scope to illustrative examples.

Memory 622 may comprise any non-transitory storage mechanism. Memory 622 may comprise, for example, primary memory 624 and secondary memory 626, additional memory circuits, mechanisms, or combinations thereof may be used. Memory 622 may comprise, for example, random access memory, read only memory, etc., such as in the form of one or more storage devices and/or systems, such as, for example, a disk drive including an optical disc drive, a tape drive, a solid-state memory drive, etc., just to name a few examples.

Memory 622 may comprise one or more articles utilized to store a program of executable computer instructions. For example, processor 620 may fetch executable instructions from memory and proceed to execute the fetched instructions. Memory 622 may also comprise a memory controller for accessing device readable-medium 640 that may carry and/or make accessible digital content, which may include code, and/or instructions, for example, executable by processor 620 and/or some other device, such as a controller, as one example, capable of executing computer instructions, for example. Under direction of processor 620, a non-transitory memory, such as memory cells storing physical states (e.g., memory states), comprising, for example, a program of executable computer instructions, may be executed by processor 620 and able to generate signals to be communicated via a network, for example, as previously described. Generated signals may also be stored in memory, also previously suggested.

Memory 622 may store electronic files and/or electronic documents, such as relating to one or more users, and may also comprise a machine-readable medium that may carry and/or make accessible content, including code and/or instructions, for example, executable by processor 620 and/or some other device, such as a controller, as one example, capable of executing computer instructions, for example. Here, as previously mentioned, the term electronic file and/or the term electronic document are used throughout this document to refer to a set of stored memory states and/or a set of physical signals associated in a manner so as to thereby form an electronic file and/or an electronic document. That is, it is not meant to implicitly reference a particular syntax, format and/or approach used, for example, with respect to a set of associated memory states and/or a set of associated physical signals. It is further noted an association of memory states, for example, may be in a logical sense and not necessarily in a tangible, physical sense. Thus, although signal and/or state components of an electronic file and/or electronic document, are to be associated logically, storage thereof, for example, may reside in one or more different places in a tangible, physical memory, in an embodiment.

Algorithmic descriptions and/or symbolic representations are examples of techniques used by those of ordinary skill in the signal processing and/or related arts to convey the substance of their work to others skilled in the art. An algorithm is, in the context of the present patent application, and generally, is considered to be a self-consistent sequence of operations and/or similar signal processing leading to a desired result. In the context of the present patent application, operations and/or processing involve physical manipulation of physical quantities. Typically, although not necessarily, such quantities may take the form of electrical and/or magnetic signals and/or states capable of being stored, transferred, combined, compared, processed and/or otherwise manipulated, for example, as electronic signals and/or states making up components of various forms of digital content, such as signal measurements, text, images, video, audio, etc.

Processor 620 may comprise one or more circuits, such as digital circuits, to perform at least a portion of a computing procedure and/or process. By way of example, but not limitation, processor 620 may comprise one or more processors, such as controllers, micro-processors, micro-controllers, application specific integrated circuits, digital signal processors, programmable logic devices, field programmable gate arrays, the like, or any combination thereof. In various implementations and/or embodiments, processor 620 may perform signal processing, typically substantially in accordance with fetched executable computer instructions, such as to manipulate signals and/or states, to construct signals and/or states, etc., with signals and/or states generated in such a manner to be communicated and/or stored in memory, for example.

FIG. 6 also illustrates device 604 as including a component 632 operable with input/output devices, and communication bus 615, for example, so that signals and/or states may be appropriately communicated between devices, such as device 604 and an input device and/or device 604 and an output device. A user may make use of an input device, such as a computer mouse, stylus, track ball, keyboard, and/or any other similar device capable of receiving user actions and/or motions as input signals. Likewise, for a device having speech to text capability, a user may speak to generate input signals. Likewise, a user may make use of an output device, such as a display, a printer, etc., and/or any other device capable of providing signals and/or generating stimuli for a user, such as visual stimuli, audio stimuli and/or other similar stimuli.

In the context of the present patent application, the term “connection,” the term “component” and/or similar terms are intended to be physical, but are not necessarily always tangible. Whether or not these terms refer to tangible subject matter, thus, may vary in a particular context of usage. As an example, a tangible connection and/or tangible connection path may be made, such as by a tangible, electrical connection, such as an electrically conductive path comprising metal or other conductor, that is able to conduct electrical current between two tangible components. Likewise, a tangible connection path may be at least partially affected and/or controlled, such that, as is typical, a tangible connection path may be open or closed, at times resulting from influence of one or more externally derived signals, such as external currents and/or voltages, such as for an electrical switch. Non-limiting illustrations of an electrical switch include a transistor, a diode, etc. However, a “connection” and/or “component,” in a particular context of usage, likewise, although physical, can also be non-tangible, such as a connection between a client and a server over a network, particularly a wireless network, which generally refers to the ability for the client and server to transmit, receive, and/or exchange communications, as discussed in more detail later.

In a particular context of usage, such as a particular context in which tangible components are being discussed, therefore, the terms “coupled” and “connected” are used in a manner so that the terms are not synonymous. Similar terms may also be used in a manner in which a similar intention is exhibited. Thus, “connected” is used to indicate that two or more tangible components and/or the like, for example, are tangibly in direct physical contact. Thus, using the previous example, two tangible components that are electrically connected are physically connected via a tangible electrical connection, as previously discussed. However, “coupled,” is used to mean that potentially two or more tangible components are tangibly in direct physical contact. Nonetheless, “coupled” is also used to mean that two or more tangible components and/or the like are not necessarily tangibly in direct physical contact, but are able to co-operate, liaise, and/or interact, such as, for example, by being “optically coupled.” Likewise, the term “coupled” is also understood to mean indirectly connected. It is further noted, in the context of the present patent application, since memory, such as a memory component and/or memory states, is intended to be non-transitory, the term physical, at least if used in relation to memory necessarily implies that such memory components and/or memory states, continuing with the example, are tangible.

Additionally, in the present patent application, in a particular context of usage, such as a situation in which tangible components (and/or similarly, tangible materials) are being discussed, a distinction exists between being “on” and being “over.” As an example, deposition of a substance “on” a substrate refers to a deposition involving direct physical and tangible contact without an intermediary, such as an intermediary substance, between the substance deposited and the substrate in this latter example; nonetheless, deposition “over” a substrate, while understood to potentially include deposition “on” a substrate (since being “on” may also accurately be described as being “over''), is understood to include a situation in which one or more intermediaries, such as one or more intermediary substances, are present between the substance deposited and the substrate so that the substance deposited is not necessarily in direct physical and tangible contact with the substrate.

A similar distinction is made in an appropriate particular context of usage, such as in which tangible materials and/or tangible components are discussed, between being “beneath” and being “under.” While “beneath,” in such a particular context of usage, is intended to necessarily imply physical and tangible contact (similar to “on,” as just described), “under'' potentially includes a situation in which there is direct physical and tangible contact, but does not necessarily imply direct physical and tangible contact, such as if one or more intermediaries, such as one or more intermediary substances, are present. Thus, “on” is understood to mean “immediately over” and “beneath” is understood to mean “immediately under.”

It is likewise appreciated that terms such as “over” and “under'' are understood in a similar manner as the terms “up,” “down,” “top,” “bottom,” and so on, previously mentioned. These terms may be used to facilitate discussion, but are not intended to necessarily restrict scope of claimed subject matter. For example, the term “over,” as an example, is not meant to suggest that claim scope is limited to only situations in which an embodiment is right side up, such as in comparison with the embodiment being upside down, for example. An example includes a flip chip, as one illustration, in which, for example, orientation at various times (e.g., during fabrication) may not necessarily correspond to orientation of a final product. Thus, if an object, as an example, is within applicable claim scope in a particular orientation, such as upside down, as one example, likewise, it is intended that the latter also be interpreted to be included within applicable claim scope in another orientation, such as right side up, again, as an example, and vice-versa, even if applicable literal claim language has the potential to be interpreted otherwise. Of course, again, as always has been the case in the specification of a patent application, particular context of description and/or usage provides helpful guidance regarding reasonable inferences to be drawn.

Unless otherwise indicated, in the context of the present patent application, the term “or'' if used to associate a list, such as A, B, or C, is intended to mean A, B, and C, here used in the inclusive sense, as well as A, B, or C, here used in the exclusive sense. With this understanding, “and” is used in the inclusive sense and intended to mean A, B, and C; whereas “and/or” can be used in an abundance of caution to make clear that all of the foregoing meanings are intended, although such usage is not required. In addition, the term “one or more” and/or similar terms is used to describe any feature, structure, characteristic, and/or the like in the singular, “and/or” is also used to describe a plurality and/or some other combination of features, structures, characteristics, and/or the like. Likewise, the term “based on” and/or similar terms are understood as not necessarily intending to convey an exhaustive list of factors, but to allow for existence of additional factors not necessarily expressly described.

Furthermore, it is intended, for a situation that relates to implementation of claimed subject matter and is subject to testing, measurement, and/or specification regarding degree, that the particular situation be understood in the following manner. As an example, in a given situation, assume a value of a physical property is to be measured. If alternatively reasonable approaches to testing, measurement, and/or specification regarding degree, at least with respect to the property, continuing with the example, is reasonably likely to occur to one of ordinary skill, at least for implementation purposes, claimed subject matter is intended to cover those alternatively reasonable approaches unless otherwise expressly indicated. As an example, if a plot of measurements over a region is produced and implementation of claimed subject matter refers to employing a measurement of slope over the region, but a variety of reasonable and alternative techniques to estimate the slope over that region exist, claimed subject matter is intended to cover those reasonable alternative techniques unless otherwise expressly indicated.

To the extent claimed subject matter is related to one or more particular measurements, such as with regard to physical manifestations capable of being measured physically, such as, without limit, temperature, pressure, voltage, current, electromagnetic radiation, etc., it is believed that claimed subject matter does not fall with the abstract idea judicial exception to statutory subject matter. Rather, it is asserted, that physical measurements are not mental steps and, likewise, are not abstract ideas.

It is noted, nonetheless, that a typical measurement model employed is that one or more measurements may respectively comprise a sum of at least two components. Thus, for a given measurement, for example, one component may comprise a deterministic component, which in an ideal sense, may comprise a physical value (e.g., sought via one or more measurements), often in the form of one or more signals, signal samples and/or states, and one component may comprise a random component, which may have a variety of sources that may be challenging to quantify. At times, for example, lack of measurement precision may affect a given measurement. Thus, for claimed subject matter, a statistical or stochastic model may be used in addition to a deterministic model as an approach to identification and/or prediction regarding one or more measurement values that may relate to claimed subject matter.

For example, a relatively large number of measurements may be collected to better estimate a deterministic component. Likewise, if measurements vary, which may typically occur, it may be that some portion of a variance may be explained as a deterministic component, while some portion of a variance may be explained as a random component. Typically, it is desirable to have stochastic variance associated with measurements be relatively small, if feasible. That is, typically, it may be preferable to be able to account for a reasonable portion of measurement variation in a deterministic manner, rather than a stochastic matter as an aid to identification and/or predictability.

Along these lines, a variety of techniques have come into use so that one or more measurements may be processed to better estimate an underlying deterministic component, as well as to estimate potentially random components. These techniques, of course, may vary with details surrounding a given situation. Typically, however, more complex problems may involve use of more complex techniques. In this regard, as alluded to above, one or more measurements of physical manifestations may be modeled deterministically and/or stochastically. Employing a model permits collected measurements to potentially be identified and/or processed, and/or potentially permits estimation and/or prediction of an underlying deterministic component, for example, with respect to later measurements to be taken. A given estimate may not be a perfect estimate; however, in general, it is expected that on average one or more estimates may better reflect an underlying deterministic component, for example, if random components that may be included in one or more obtained measurements, are considered. Practically speaking, of course, it is desirable to be able to generate, such as through estimation approaches, a physically meaningful model of processes affecting measurements to be taken.

In some situations, however, as indicated, potential influences may be complex. Therefore, seeking to understand appropriate factors to consider may be particularly challenging. In such situations, it is, therefore, not unusual to employ heuristics with respect to generating one or more estimates. Heuristics refers to use of experience related approaches that may reflect realized processes and/or realized results, such as with respect to use of historical measurements, for example. Heuristics, for example, may be employed in situations where more analytical approaches may be overly complex and/or nearly intractable. Thus, regarding claimed subject matter, an innovative feature may include, in an example embodiment, heuristics that may be employed, for example, to estimate and/or predict one or more measurements.

It is further noted that the terms “type” and/or “like,” if used, such as with a feature, structure, characteristic, and/or the like, using “optical” or “electrical” as simple examples, means at least partially of and/or relating to the feature, structure, characteristic, and/or the like in such a way that presence of minor variations, even variations that might otherwise not be considered fully consistent with the feature, structure, characteristic, and/or the like, do not in general prevent the feature, structure, characteristic, and/or the like from being of a “type” and/or being “like,” (such as being an “optical-type” or being “optical-like,” for example) if the minor variations are sufficiently minor so that the feature, structure, characteristic, and/or the like would still be considered to be substantially present with such variations also present. Thus, continuing with this example, the terms optical-type and/or optical-like properties are necessarily intended to include optical properties. Likewise, the terms electrical-type and/or electrical-like properties, as another example, are necessarily intended to include electrical properties. It should be noted that the specification of the present patent application merely provides one or more illustrative examples and claimed subject matter is intended to not be limited to one or more illustrative examples; however, again, as has always been the case with respect to the specification of a patent application, particular context of description and/or usage provides helpful guidance regarding reasonable inferences to be drawn.

With advances in technology, it has become more typical to employ distributed computing and/or communication approaches in which portions of a process, such as signal processing of signal samples, for example, may be allocated among various devices, including one or more communications devices and/or one or more server devices, via a computing and/or communications network, for example. A network may comprise two or more devices, such as network devices and/or computing devices, and/or may couple devices, such as network devices and/or computing devices, so that signal communications, such as in the form of signal packets and/or signal frames (e.g., comprising one or more signal samples), for example, may be exchanged, such as between a client server device and/or a communications device, as well as other types of devices, including between wired and/or wireless devices coupled via a wired and/or wireless network, for example.

In the context of the present patent application, the term network device refers to any device capable of communications via and/or as part of a network and may comprise a computing device. While network devices may be capable of communications signals (e.g., signal packets and/or frames), such as via a wired and/or wireless network, they may also be capable of performing operations associated with a computing device, such as arithmetic and/or logic operations, processing and/or storing operations (e.g., storing signal samples), such as in memory as tangible, physical memory states, and/or may, for example, operate as a communications device and/or a client server device in various embodiments. Network devices capable of operating as a client server, may include, as examples, dedicated rack-mounted servers, desktop computers, laptop computers, set top boxes, tablets, netbooks, smart phones, wearable devices, integrated devices combining two or more features of the foregoing devices, and/or the like, or any combination thereof. As mentioned, signal packets and/or frames, for example, may be exchanged, such as between a server device and/or a communications device, as well as other types of devices, including between wired and/or wireless devices coupled via a wired and/or wireless network, for example, or any combination thereof. It is noted that the terms, server, server device, server computing device, server computing platform and/or similar terms are used interchangeably.

It should be understood that for ease of description, a network device (also referred to as a networking device) may be embodied and/or described in terms of a computing device and vice-versa. However, it should further be understood that this description should in no way be construed so that claimed subject matter is limited to one embodiment, such as only a computing device and/or only a network device, but, instead, may be embodied as a variety of devices or combinations thereof, including, for example, one or more illustrative examples.

In the context of the present patent application, the term sub-network and/or similar terms, if used, for example, with respect to a network, refers to the network and/or a part thereof. Sub-networks may also comprise links, such as physical links, connecting and/or coupling nodes, so as to be capable to communicate signal packets and/or frames between devices of particular nodes, including via wired links, wireless links, or combinations thereof. Various types of devices, such as network devices and/or computing devices, may be made available so that device interoperability is enabled and/or, in at least some instances, may be transparent. In the context of the present patent application, the term “transparent,” if used with respect to devices of a network, refers to devices communications via the network in which the devices are able to communicate via one or more intermediate devices, such as one or more intermediate nodes, but without the communications devices necessarily specifying the one or more intermediate nodes and/or the one or more intermediate devices of the one or more intermediate nodes and/or, thus, may include within the network the devices communications via the one or more intermediate nodes and/or the one or more intermediate devices of the one or more intermediate nodes, but may engage in signal communications as if such intermediate nodes and/or intermediate devices are not necessarily involved. For example, a router may provide a link and/or connection between otherwise separate and/or independent LANs.

The term electronic file and/or the term electronic document are used throughout this document to refer to a set of stored memory states and/or a set of physical signals associated in a manner so as to thereby, at least logically, form a file (e.g., electronic) and/or an electronic document. That is, it is not meant to implicitly reference a particular syntax, format and/or approach used, for example, with respect to a set of associated memory states and/or a set of associated physical signals. If a particular type of file storage format and/or syntax, for example, is intended, it is referenced expressly. It is further noted an association of memory states, for example, may be in a logical sense and not necessarily in a tangible, physical sense. Thus, although signal and/or state components of a file and/or an electronic document, for example, are to be associated logically, storage thereof, for example, may reside in one or more different places in a tangible, physical memory, in an embodiment.

Also, for one or more embodiments, an electronic document and/or electronic file may comprise a number of components. As previously indicated, in the context of the present patent application, a component is physical, but is not necessarily tangible. As an example, components with reference to an electronic document and/or electronic file, in one or more embodiments, may comprise text, for example, in the form of physical signals and/or physical states (e.g., capable of being physically displayed). Typically, memory states, for example, comprise tangible components, whereas physical signals are not necessarily tangible, although signals may become (e.g., be made) tangible, such as if appearing on a tangible display, for example, as is not uncommon. Also, for one or more embodiments, components with reference to an electronic document and/or electronic file may comprise a graphical object, such as, for example, an image, such as a digital image, and/or sub-objects, including attributes thereof, which, again, comprise physical signals and/or physical states (e.g., capable of being tangibly displayed). In an embodiment, digital content may comprise, for example, text, images, audio, video, and/or other types of electronic documents and/or electronic files, including portions thereof, for example.

For one or more embodiments, a device, such as a computing device and/or networking device, may comprise, for example, any of a wide range of digital electronic devices, including, but not limited to, desktop and/or notebook computers, high-definition televisions, digital versatile disc (DVD) and/or other optical disc players and/or recorders, game consoles, satellite television receivers, cellular telephones, tablet devices, wearable devices, personal digital assistants, mobile audio and/or video playback and/or recording devices, Internet of Things (IoT) type devices, or any combination of the foregoing. Further, unless specifically stated otherwise, a process as described, such as with reference to flow diagrams and/or otherwise, may also be executed and/or affected, in whole or in part, by a computing device and/or a network device. A device, such as a computing device and/or network device, may vary in terms of capabilities and/or features. Claimed subject matter is intended to cover a wide range of potential variations. For example, a device may include a numeric keypad and/or other display of limited functionality, such as a monochrome liquid crystal display (LCD) for displaying text, for example. In contrast, however, as another example, a web-enabled device may include a physical and/or a virtual keyboard, mass storage, one or more accelerometers, one or more gyroscopes, global positioning system (GPS) and/or other location-identifying type capability, and/or a display with a higher degree of functionality, such as a touch-sensitive color 2D or 3D display, for example.

As suggested previously, communications between a computing device and/or a network device and a wireless network may be in accordance with known and/or to be developed network protocols including, for example, global system for mobile communications (GSM), enhanced data rate for GSM evolution (EDGE), 802.11b/g/n/h, etc., and/or worldwide interoperability for microwave access (WiMAX). As suggested previously, a computing device and/or a networking device may also have a subscriber identity module (SIM) card, which, for example, may comprise a detachable or embedded smart card that is able to store subscription content of a subscriber, and/or is also able to store a contact list. It is noted, as previously mentioned, that a SIM card may also be electronic in the sense that it may simply be sorted in a particular location in memory of the computing and/or networking device. A user may own the computing device and/or network device or may otherwise be a user, such as a primary user, for example. A device may be assigned an address by a wireless network operator, a wired network operator, and/or an Internet Service Provider (ISP). For example, an address may comprise a domestic or international telephone number, an Internet Protocol (IP) address, and/or one or more other identifiers. In other embodiments, a computing and/or communications network may be embodied as a wired network, wireless network, or any combinations thereof.

A computing and/or network device may include and/or may execute a variety of now known and/or to be developed operating systems, derivatives and/or versions thereof, including computer operating systems, such as Windows, iOS, Linux, a mobile operating system, such as iOS, Android, Windows Mobile, and/or the like. A computing device and/or network device may include and/or may execute a variety of possible applications, such as a communications device application enabling communication with other devices. For example, one or more messages (e.g., content) may be communicated, such as via one or more protocols, now known and/or later to be developed, suitable for communication of email, short message service (SMS), and/or multimedia message service (MMS), including via a network, such as a social network, formed at least in part by a portion of a computing and/or communications network. A computing and/or network device may also include executable computer instructions to process and/or communicate digital content, such as, for example, textual content, digital multimedia content, and/or the like. A computing and/or network device may also include executable computer instructions to perform a variety of possible tasks, such as browsing, searching, playing various forms of digital content, including locally stored and/or streamed video, and/or games such as, but not limited to, fantasy sports leagues. The foregoing is provided merely to illustrate that claimed subject matter is intended to include a wide range of possible features and/or capabilities.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

What is claimed is:

1. A method, comprising:
obtaining, from a client computing resource, a first subscriber identifier currently assigned to a communications device;
determining whether a link exists between the first subscriber identifier and one or more subscriber identifiers previously or subsequently assigned to the communications device; and
transmitting, to the client computing resource, the one or more subscriber identifiers previously or subsequently assigned to the communications device;
wherein the first subscriber identifier was assigned to the communications device at a first time;
wherein the one or more subscriber identifiers previously or subsequently assigned to the communications device include a second subscriber identifier that was assigned to the communications device at a second time, the second time occurring before the first time; and
wherein the one or more subscriber identifiers previously or subsequently assigned to the communications device include a third subscriber identifier that was assigned to the communications device at a third time, the third time occurring after the first time.

2. The method of claim 1, further comprising:
transmitting a trust score to the client computing resource.

3. The method of claim 2, further comprising:
computing the trust score based, at least in part, on deterministic behaviors with respect to the communications device.

4. The method of claim 3, wherein the deterministic behaviors with respect to the communications device comprise communications device tenure, removal and/or replacement of a subscriber identity module (SIM) of the communications device, use of a one-time code to reset an account password of the communications device, or recent porting of a telephone number corresponding to the communications device.

5. The method of claim 2, further comprising:
transmitting a reliability metric to the client computing resource.

6. The method of claim 5, further comprising:
computing the reliability metric based, at least in part, on a measure of velocity or a measure of frequency with which the one or more subscriber identifiers were previously or subsequently assigned to the communications device by a communication services carrier.

7. The method of claim 5, further comprising:
designating for monitoring one or more of first subscriber identifier, the second subscriber identifier, or the third subscriber identifier, based, at least in part on, the reliability metric being less than a threshold.

8. The method of claim 1, wherein obtaining the first subscriber identifier from the client computing resource occurs responsive to establishing a web browser-based session having an interface to accept input signals from a user.

9. An apparatus, comprising:
a processor coupled to at least one memory device adapted to:
obtain, from a client computing resource, a first subscriber identifier currently assigned to a communications device;
detect a link between the first subscriber identifier and one or more subscriber identifiers previously or subsequently assigned to the communications device; and
transmit, to the client computing resource, the one or more subscriber identifiers previously or subsequently assigned to the communications device;
wherein the first subscriber identifier was assigned to the communications device at a first time;
wherein the one or more subscriber identifiers previously or subsequently assigned to the communications device include a second subscriber identifier that was assigned to the communications device at a second time, the second time occurring before the first time; and
wherein the one or more subscriber identifiers previously or subsequently assigned to the communications device include a third subscriber identifier that was assigned to the communications device at a third time, the third time occurring after the first time.

10. The apparatus of claim 9, wherein the processor coupled to the at least one memory device is further adapted to transmit a trust score to the client computing resource.

11. The apparatus of claim 10, wherein the processor coupled to the at least one memory device is further adapted to compute the trust score based, at least in part, on deterministic behaviors with respect to the communications device, wherein the deterministic behaviors correspond to communications device tenure, removal and/or replacement of a subscriber identity module (SIM) of the communications device, use of a one-time code to reset an account password of the communications device, recent porting of a telephone number corresponding to the communications device, or any combination thereof.

12. The apparatus of claim 10, wherein the processor coupled to the at least one memory device is further adapted to transmit a reliability metric, which qualifies the trust score, to the client computing resource.

13. The apparatus of claim 12, wherein the processor coupled to the at least one memory device is further adapted to compute the reliability metric based at least in part on a measure of velocity or a measure of frequency with which the one or more subscriber identifiers were previously or subsequently assigned to the communications device by a communication services carrier.

14. The apparatus of claim 12, wherein the processor coupled to the at least one memory device is further adapted to designate for monitoring one or more of the first subscriber identifier, the second subscriber identifier, or the third subscriber identifier, based at least in part on the reliability metric being less than a threshold.

15. An article comprising:
one or more non-transitory computer-readable storage media including instructions that, when executed by one or more processors, cause the one or more processors to perform steps of:
obtain, from a client computing resource, a first subscriber identifier currently assigned to a communications device;
detect a link between the first subscriber identifier and one or more subscriber identifiers previously or subsequently assigned to the communications device; and
transmit, to the client computing resource, the one or more subscriber identifiers previously or subsequently assigned to the communications device;
wherein the first subscriber identifier was assigned to the communications device at a first time;
wherein the one or more subscriber identifiers previously or subsequently assigned to the communications device include a second subscriber identifier that was assigned to the communications device at a second time, the second time occurring before the first time; and
wherein the one or more subscriber identifiers previously or subsequently assigned to the communications device include a third subscriber identifier that was assigned to the communications device at a third time, the third time occurring after the first time.

16. The article of claim 15, wherein when executed by one or more processors, the instructions further cause the one or more processors to transmit a trust score to the client computing resource.

17. The article of claim 16, wherein when executed by one or more processors, the instructions further cause the one or more processors to compute the trust score based, at least in part, on deterministic behaviors with respect to the communications device, wherein the deterministic behaviors correspond to communications device tenure, removal and/or replacement of a subscriber identity module (SIM) of the communications device, use of a one-time code to reset an account password of the communications device, recent porting of a telephone number corresponding to the communications device, or any combination thereof.

18. The article of claim 16, wherein when executed by one or more processors, the instructions further cause the one or more processors to transmit a reliability metric, which qualifies the trust score, to the client computing resource.

19. The article of claim 18, wherein when executed by one or more processors, the instructions further cause the one or more processors to compute the reliability metric based at least in part on a measure of velocity or a measure of frequency with which the one or more subscriber identifiers were previously or subsequently assigned to the communications device by a communication services carrier.

20. The article of claim 18, wherein when executed by one or more processors, the instructions further cause the one or more processors to designate for monitoring one or more of the first subscriber identifier, the second subscriber identifier, or the third subscriber identifier, based at least in part on the reliability metric being less than a threshold.
